(19) United States
(12) Patent Application Publication
(10) Pub. No.: US 2026/0205263 A1
(43) Pub. Date: Jul. 16, 2026

(54) Method for Providing Asymmetric Encryption for SMS Communications

(71) Applicant: Private Tech, Inc., Arlington, VA (US)

(72) Inventors: John McKinstry Doyle, Arlington, VA (US); Stephen James Dowhy, Arlington, VA (US); Benny Tran, Arlington, VA (US); Abhiti Garima Vaish, Arlington, VA (US)

(21) Appl. No.: 19/445,499

(22) Filed: Jan. 10, 2026

Related U.S. Application Data
(60) Provisional application No. 63/743,783, filed on Jan. 10, 2025.

(51) Int. Cl. H04L 9/08

(52) U.S. Cl. CPC H04L 9/0816; H04L 2463/082

(57) ABSTRACT

Disclosed is a method for providing asymmetric encryption for SMS communications includes generating a public key and a private key associated with a mobile subscriber, storing the private key on a mobile device of the mobile subscriber, sharing the public key with a 2FA distribution service, receiving by the, 2FA distribution service, a 2FA code for the mobile subscriber, generating an encrypted 2FA code with the public key, sending the encrypted 2FA code to a mobile network of the mobile subscriber, sending, by the mobile network, the encrypted 2FA code to the mobile device, and decrypting, by the mobile device the encrypted 2FA code using the private key.

### BACKGROUND OF THE INVENTION

This application is a continuation-in-part of U.S. Application 63/743,783 filed January 10, 2025 the entirety of which is hereby incorporated by reference.

### FIELD OF THE INVENTION

The embodiments of the invention relate text messaging, and more particularly, to encrypted text messaging. Although embodiments of the invention are suitable for a wide scope of applications, it is particularly suitable for providing encrypted text messaging with minimal user friction.

### Discussion of the Related Art

In the related art, text messages are transmitted through a multi-stage process involving several network components. When a user composes and sends a text message on a mobile device, the message is first transmitted via radio frequency signals to a nearby cellular base station or cell tower. The base station forwards the message to a Mobile Switching Center (MSC), which routes the message through the carrier's core network infrastructure. For SMS messages, the MSC directs the message to a Short Message Service Center (SMSC), which acts as a store-and-forward system responsible for queuing, routing, and delivering messages to their intended recipients. The SMSC queries a Home Location Register (HLR) database to determine the recipient's current location and network status.

Once the recipient's serving MSC is identified, the SMSC transmits the message to that MSC, which then delivers the message to the recipient's mobile device through the appropriate base station. If the recipient device is unavailable or powered off, the SMSC stores the message and attempts redelivery at periodic intervals until successful delivery or message expiration. For MMS messages, a similar process occurs, but the message content is routed through an MMS Center (MMSC) that handles the larger multimedia payloads and performs content adaptation as needed. Throughout this transmission pathway, the message content traverses multiple network nodes and may be temporarily stored at various points, creating numerous opportunities for interception or unauthorized access.

Under current text messaging standards, multiple components of a text message remain unencrypted during transmission and storage. The message body itself, containing the actual textual content composed by the sender, is transmitted in plaintext format across the network infrastructure. This includes all alphanumeric characters, special symbols, and any embedded content within the message payload.

Beyond the message body, the message header information remains unencrypted, including the originating address (sender's phone number or short code), the destination address (recipient's phone number), and the service center address identifying the SMSC handling the message. Protocol identifier fields that specify the type of message and the higher layer protocol being used are also transmitted without encryption.

Timestamp data associated with the message, including the service center timestamp indicating when the SMSC received the message and delivery timestamps, remain exposed in plaintext. User data header information, which may contain concatenation references for multi-part messages, port addressing information, and special feature indicators, is similarly unencrypted.

For MMS messages, additional unencrypted components include the message subject line, content type descriptors identifying the media formats contained within the message, and presentation information controlling how multimedia elements are displayed. The actual multimedia content, including images, audio files, video clips, and other attachments, is transmitted without encryption protection.

Network-level metadata that accompanies message transmission also remains unencrypted, including International Mobile Subscriber Identity (IMSI) numbers, International Mobile Equipment Identity (IMEI) numbers, cell tower identifiers revealing approximate geographic location, and routing information used to direct messages through the network. Delivery status reports and read receipts, when enabled, similarly traverse the network in plaintext format, revealing information about message receipt and user interaction patterns.

Current SMS encryption protocols provide limited security protections that fall short of comprehensive end-to-end encryption standards. The GSM (Global System for Mobile Communications) standard employs the A5/1 stream cipher algorithm to encrypt voice and data transmissions over the air interface between mobile devices and base stations. However, this encryption only protects the radio link segment and does not extend through the entire transmission pathway. The A5/1 algorithm, developed in the late 1980s, has been demonstrated to be cryptographically weak and susceptible to various attacks, including real-time decryption using rainbow tables and known-plaintext attacks. Some networks utilize the even weaker A5/2 algorithm or operate with encryption disabled entirely (A5/0 mode). The successor 3G networks introduced the KASUMI block cipher (also known as A5/3), which provides improved security over A5/1 but has also been shown to have theoretical vulnerabilities. LTE (4G) networks employ the SNOW 3G, AES, and ZUC algorithms for air interface encryption, offering stronger cryptographic protection for the radio segment. However, across all these generations of cellular technology, the encryption terminates at the network edge, meaning that message content travels in plaintext through the carrier's core network infrastructure, including through the SMSC where messages are stored and processed. The 3GPP standards do not mandate end-to-end encryption for SMS content, leaving messages exposed at multiple points within the carrier network. Additionally, inter-carrier message transmission often occurs without encryption, as messages traverse SS7 (Signaling System 7) networks that were designed without modern security considerations and remain vulnerable to interception and manipulation attacks.

The RCS (Rich Communication Services) protocol, intended as a successor to SMS, offers optional encryption capabilities but implementation varies significantly across carriers and devices, and end-to-end encryption is not universally deployed. Consequently, the existing SMS encryption framework provides only partial protection limited to specific network segments while leaving substantial portions of the message transmission and storage pathway unprotected.

The transmission of unencrypted text messages presents numerous security and privacy vulnerabilities that expose users to significant risks. First, message interception represents a primary concern, as plaintext messages can be captured and read by malicious actors who gain access to any point along the transmission pathway, including through compromised base stations, rogue cell towers, or man-in-the-middle attacks. Second, network operator access poses privacy concerns because carrier personnel and systems can access message content during transmission and storage, creating potential for unauthorized viewing, data mining, or disclosure to third parties. Third, government surveillance capabilities are enhanced when messages lack encryption, as law enforcement and intelligence agencies can compel carriers to provide message content through legal processes or, in some jurisdictions, through extralegal means. Fourth, data breach vulnerability increases substantially when messages are stored in plaintext on carrier servers, as successful attacks on these centralized repositories can expose vast quantities of private communications simultaneously. Fifth, SIM swapping and account takeover attacks become more damaging when authentication codes and sensitive information transmitted via unencrypted SMS can be intercepted by attackers who have fraudulently transferred a victim's phone number to a device under their control. Sixth, the lack of message integrity verification in unencrypted systems means that messages can potentially be altered in transit without detection, enabling spoofing attacks and fraudulent communications. Seventh, metadata exposure accompanying unencrypted messages allows for comprehensive surveillance of communication patterns, social networks, and user behaviors even when message content itself might be protected by other means. Eighth, enterprise and regulatory compliance requirements increasingly mandate encryption for sensitive communications, rendering unencrypted text messaging unsuitable for healthcare, financial, legal, and other regulated industries where confidentiality obligations exist. These cumulative deficiencies demonstrate that unencrypted text messaging fails to provide adequate protection for modern communication security requirements.

Thus, there is a need for providing encryption for text messaging where encryption is not supported by current protocols or current systems.

### SUMMARY OF THE INVENTION

Accordingly, embodiments of the invention are directed to a method for providing asymmetric encryption for SMS communications that substantially obviates one or more of the problems due to limitations and disadvantages of the related art.

An object of embodiments of the invention is to provide method for secure messaging over cellular networks.

Another object of embodiments of the invention is to provide message encryption over roaming providers and beyond network edges.

Yet another object of embodiments of the invention is to provide message encryption over networks that have not adopted encryption protocols.

Additional features and advantages of embodiments of the invention will be set forth in the description which follows, and in part will be apparent from the description, or may be learned by practice of embodiments of the invention. The objectives and other advantages of the embodiments of the invention will be realized and attained by the structure particularly pointed out in the written description and claims hereof as well as the appended drawings.

To achieve these and other advantages and in accordance with the purpose of embodiments of the invention, as embodied and broadly described, a method for providing asymmetric encryption for SMS communications includes generating a public key and a private key associated with a mobile subscriber, storing the private key on a mobile device of the mobile subscriber, sharing the public key with a 2FA distribution service, receiving by the, 2FA distribution service, a 2FA code for the mobile subscriber, generating an encrypted 2FA code with the public key, sending the encrypted 2FA code to a mobile network of the mobile subscriber, sending, by the mobile network, the encrypted 2FA code to the mobile device, and decrypting, by the mobile device the encrypted 2FA code using the private key.

In another aspect, method for providing asymmetric encryption for SMS communications includes generating a public key and a private key associated with a mobile subscriber, storing the private key on a mobile device of the mobile subscriber, receiving, by a home network, an unencrypted text message for a mobile subscriber, encrypting the unencrypted text message using the public key to create an encrypted text message, sending the encrypted text message to the mobile device, and decrypting the encrypted text message using the private key on the mobile device to yield the unencrypted text message.

In yet another aspect, method for providing asymmetric encryption for SMS communications includes generating a public key and a private key associated with a first device, storing the public key on a mobile network, requesting, by a mobile device, the public key, generating an encrypted text message from an unencrypted text message using the public key, sending the encrypted text message to the mobile network by the second device, sending the encrypted text message to the first device by the mobile network, and decrypting the encrypted text message using the private key on the first device.

It is to be understood that both the foregoing general description and the following detailed description are exemplary and explanatory and are intended to provide further explanation of embodiments of the invention as claimed.

### BRIEF DESCRIPTION OF THE DRAWINGS

The accompanying drawings, which are included to provide a further understanding of embodiments of the invention and are incorporated in and constitute a part of this specification, illustrate embodiments of the invention and together with the description serve to explain the principles of embodiments of the invention.

FIG. 1 is a flow chart of generating and distributing encryption keys according to an exemplary embodiment of the invention; and

FIG. 2 is a flow chart of encryption SMS communications according to an exemplary embodiment of the invention.

### DETAILED DESCRIPTION OF THE PREFERRED EMBODIMENTS

Reference will now be made in detail to the preferred embodiments of the invention, examples of which are illustrated in the accompanying drawings. The invention may, however, be embodied in many different forms and should not be construed as being limited to the embodiments set forth herein; rather, these embodiments are provided so that this disclosure will be thorough and complete, and will fully convey the concept of the invention to those skilled in the art. In the drawings, the thicknesses of layers and regions are exaggerated for clarity. Like reference numerals in the drawings denote like elements.

Embodiments of the invention, generally, seek to redirect traditional SMS messages to more secure channels and provide a method and system for routing and encrypting messages over the secure channels even when one of the sender or receiver does not employ or participate in the enhanced signaling methods of the present invention. Embodiments of the invention provide the most secure transmission methods available based on the collective capabilities of the sending device, receiving device, and their respective networks.

Embodiments of the invention are implemented substantially in software, with executable instructions stored in non-transitory computer-readable storage media and executed by one or more processors of mobile devices, servers, or other computing apparatus. The non-transitory computer-readable storage media may include, without limitation, read-only memory (ROM), random access memory (RAM), electrically erasable programmable read-only memory (EEPROM), flash memory devices, magnetic disk storage, optical disc storage, solid-state drives, or any other tangible medium capable of storing digital information in a form retrievable by a processing device. The one or more processors may comprise general-purpose central processing units (CPUs), graphics processing units (GPUs), digital signal processors (DSPs), application-specific integrated circuits (ASICs), field-programmable gate arrays (FPGAs), or specialized cryptographic coprocessors designed to accelerate encryption and decryption operations.

Mobile devices on which embodiments may be executed include smartphones, tablet computers, wearable computing devices, and other portable communication apparatus equipped with cellular connectivity and SMS/MMS transmission capabilities. Server implementations may execute on dedicated hardware, virtualized computing environments, or cloud computing infrastructure to provide centralized key management, message relay, or other supporting services. The executable instructions, when loaded into memory and executed by the one or more processors, cause the computing apparatus to perform the encryption, decryption, and secure messaging operations described herein.

Aspects of the invention may utilize a database for storing and referencing encryption keys, message content, and other data. The database may be implemented using relational database management systems (RDBMS) such as MySQL, PostgreSQL, SQLite, or Microsoft SQL Server, or alternatively using non-relational database technologies including key-value stores, document databases, or distributed ledger systems depending on the specific requirements of the implementation. In embodiments deployed on mobile devices, the database may comprise a lightweight embedded database engine that operates locally within the device's storage subsystem, enabling offline access to encryption keys, contact information, and message history without requiring network connectivity. Server-based implementations may utilize enterprise-grade database systems capable of handling concurrent access from multiple users while maintaining data integrity and supporting high-availability configurations.

The databases can store various categories of data relating to the secure messaging functionality described herein. Public key records associate user identifiers with their corresponding public encryption keys, enabling the system to retrieve the appropriate key when encrypting messages destined for a particular recipient. Private key storage, when implemented in database form rather than hardware security modules, employs additional encryption layers to protect the stored key material using device-specific credentials or user-supplied passphrases.

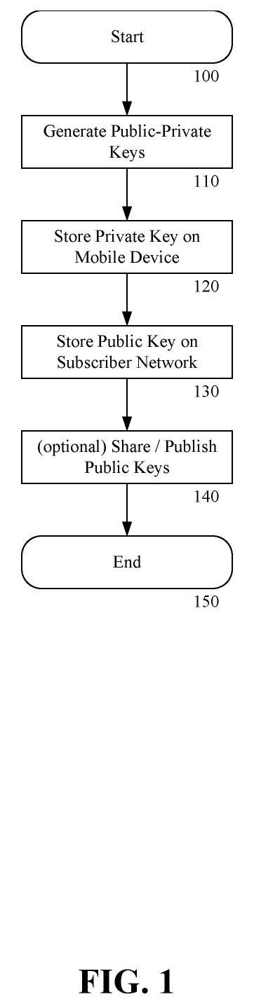

FIG. 1 is a flow chart of generating and distributing encryption keys according to an exemplary embodiment of the invention. As shown in FIG. 1, generating and distributing encryption keys can include generating keys 110, storing a private key on a mobile device 120, storing a public key on a subscriber network 130, and sharing/publishing public keys 140. The process can be invoked in step 100 during the original provisioning of a mobile device on a mobile network (subscriber network). The process can end in step 150 when the encryption keys are generated and stored.

In step 110, a public-private key pair can be generated upon initial provisioning of a mobile device. Initial provisioning of a mobile device can include setting up the mobile device for the first time on the subscriber network wherein the mobile device is registered with the subscriber network and authorized to access network services such as voice and data. During registration, the device can transmit its International Mobile Equipment Identity (IMEI) and the International Mobile Subscriber Identity (IMSI) stored on the Subscriber Identity Module (SIM) card to the network infrastructure.

The provisioning process can also establish the device's capabilities and service entitlements, including supported frequency bands, data service tiers, messaging permissions, and supplementary service subscriptions. For devices implementing embodiments of the present invention, the provisioning phase can additionally include the generation of cryptographic key pairs.

Many methods of asymmetric key encryption are known and can be used with the present invention and, accordingly, the invention is not limited to a specific encryption algorithm. Asymmetric key encryption, also known as public key cryptography, employs mathematically related key pairs consisting of a public key that can be freely distributed and a private key known to the owner. Unlike symmetric encryption schemes where the same key is used for both encryption and decryption operations, asymmetric algorithms enable secure communication between parties who have not previously exchanged secret key material, making them particularly suitable for establishing secure channels over untrusted networks such as cellular messaging infrastructure.

The RSA (Rivest-Shamir-Adleman) algorithm is one such asymmetric encryption algorithm and represents one of the most widely deployed asymmetric encryption systems. The RSA algorithm derives its security from the computational difficulty of factoring the product of two large prime numbers. Elliptic Curve Cryptography (ECC) provides an alternative asymmetric encryption framework based on the algebraic structure of elliptic curves over finite fields. ECC offers equivalent security to RSA with substantially smaller key sizes, making it particularly advantageous for resource-constrained mobile devices where computational efficiency and storage limitations are relevant considerations. A 256-bit ECC key provides security comparable to a 3072-bit RSA key while requiring less computational overhead for key generation, encryption, and decryption operations.

In step 120, the private key generated in step 110 can be saved on the mobile device. The private key can be used to decrypt communications previously encrypted with the corresponding public key.

In step 130, the public key can be stored on the subscriber network. The public key stored on the subscriber network can be used for encrypting communications to be sent to the mobile device.

In optional step 140, the public key can be shared or published. In some embodiments of the invention, third parties may desire to send encrypted messages to a mobile device on the subscriber network. In these embodiments, these third parties can access the public key for purposes of encrypting messages to be sent to the mobile device. In some embodiments, copies of the public keys are shared and third parties such as other network or messaging providers maintain a database of public keys on the subscriber network. In other embodiments, the public keys are made available to third parties via an API so that the third parties may access public encryption keys for a particular subscriber whenever they are needed. The third party can optionally cache encryption keys received from the subscriber network. The third party can delete encryption keys after a preset interval to avoid unchecked cache growth. The third party can re-request encryption keys after a preset interval to ensure that it always has the most recent encryption keys.

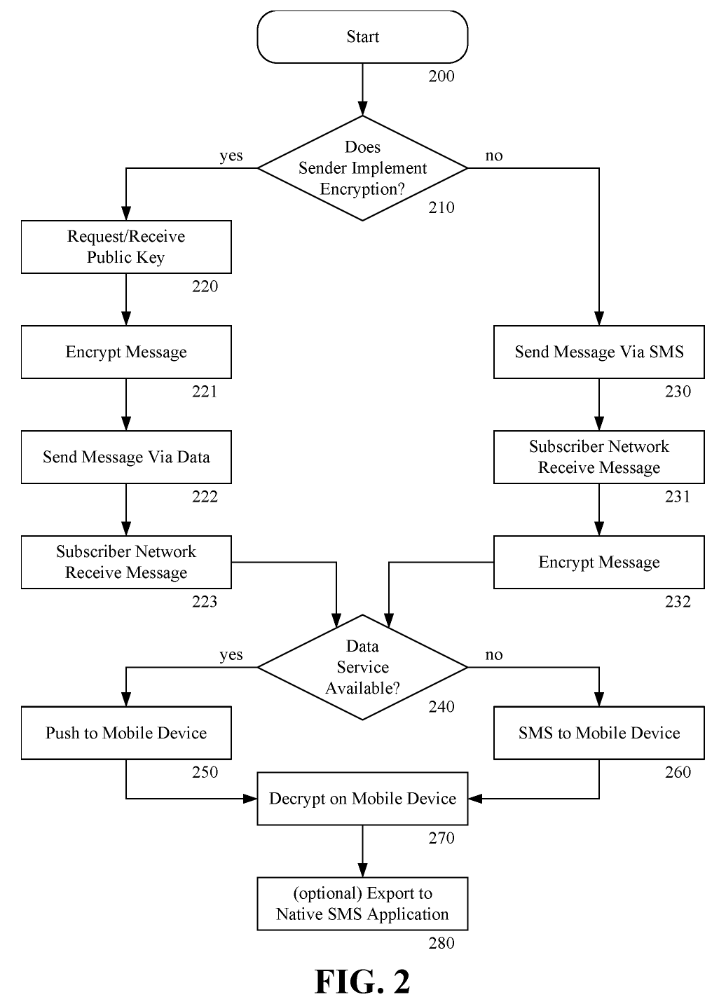

FIG. 2 is a flow chart of encryption SMS communications according to an exemplary embodiment of the invention. FIG. 2 illustrates an exemplary process flow of sending an SMS message to a subscriber on a subscriber network where the sender implements (or does not implement) portions of the improved encryption algorithm described herein. Embodiments of the invention provide the best encryption available. Best encryption can include both the sender and receiver implementing the improved algorithms described herein. However, given the breadth of SMS implementations and variety of providers, it is contemplated that a sender may not implement all of the improved encryption methods described herein and, accordingly, embodiments of the invention may seek to provide partial encryption.

As shown in FIG. 2, the process can start in step 200 when a sender desires to send a text message to a mobile device on the subscriber network.

First, in decision step 210, the sender (or the sender’s network) determines whether to implement the improved cryptographic methods of the present invention (or not). If the sender does not implement the improved cryptographic methods of the present invention, the process proceeds to step 230 where a message is sent via conventional SMS. If the sender does implement the improved cryptographic methods of the present invention, the process proceeds to step 220.

In commercial embodiments of the invention, it is contemplated that some networks may implement the invention, while other networks may be unaware of the invention or determine not to implement the invention. In decision step 210, the processes of the invention can revert to conventional technology (230) where the other network has not implemented the invention. Thus, the inventive methods described herein can work with both participating and non-participating networks.

In step 220, a sender can request and receive the public key of the recipient. The public key can be requested in real-time or stored in advance. The public key can be requested from a cached copy on the sender’s network, directly from the subscriber’s network, or directly from the recipient device.

In step 221, the sender can encrypt the message with the public key. The encryption operation transforms the plaintext message content into ciphertext that can only be decrypted by the holder of the corresponding private key. When employing RSA encryption, the sender applies the recipient's public key exponent to the message data modulo the public key modulus, producing an encrypted output of equivalent bit length to the modulus. When employing elliptic curve cryptography, the sender may utilize an Elliptic Curve Integrated Encryption Scheme (ECIES) wherein the sender generates an ephemeral key pair, computes a shared secret using the recipient's public key, derives a symmetric encryption key from the shared secret, encrypts the message content using the derived symmetric key, and transmits both the ephemeral public key and the symmetrically encrypted ciphertext to the recipient.

The encryption operation may additionally include the generation of a message authentication code or digital signature to provide integrity verification and non-repudiation, ensuring that the recipient can verify that the message has not been altered in transit and confirming the identity of the sender.

In step 222, the sender can send the encrypted message via data (e.g. Internet) to the subscriber network. The transmission via data services rather than traditional SMS pathways provides several advantages for encrypted message delivery. Data transmission utilizes Internet Protocol (IP) based communication channels that can accommodate the potentially larger payload sizes resulting from encryption overhead, including the ciphertext itself, any ephemeral public keys required for key encapsulation, message authentication codes, and metadata necessary for proper decryption at the recipient device.

The data transmission may be accomplished through various transport mechanisms including Transmission Control Protocol (TCP) connections that provide reliable, ordered delivery with automatic retransmission of lost packets, or User Datagram Protocol (UDP) connections that offer lower latency for time-sensitive communications. In preferred embodiments, the data transmission employs Transport Layer Security (TLS) to provide an additional encryption layer protecting the already-encrypted message content during transit, thereby implementing defense-in-depth security principles.

The sender may transmit the encrypted message to an application programming interface (API) endpoint hosted by the subscriber network, wherein the API endpoint is configured to receive encrypted message payloads and route them to the appropriate recipient device. The API communication may utilize RESTful web service conventions with the encrypted message payload encoded in base64 format within a JSON or XML request body, or alternatively may employ binary protocols optimized for efficient transmission of encrypted data.

In embodiments where the sender is a mobile device, the data transmission may traverse the sender's cellular data network, WiFi connection, or other available Internet connectivity before reaching the subscriber network infrastructure. In embodiments where the sender is a service provider such as a 2FA distribution service, the data transmission may originate from server infrastructure connected to the Internet via high-bandwidth enterprise network connections.

In step 223, the subscriber network can receive the encrypted message. The encrypted message can be received via various intermediaries en route between the sender and the subscriber network.

In an example of steps 210-223, a first device on a first network that implements the invention may desire to send a text message to a second device on a second network that also implements the invention. The first device may request the public key of the second device from a key store on the first network, on the second network, or directly from the second device. If requested from the first network, the first network may, in turn, request the public key of the second device from the second network or may have previously cached the public key. Upon the first device receiving the public key, it may encrypt the message with the public key. The encrypted message may be sent via data services (e.g. the Internet) rather than traditional SMS. The encrypted message may traverse from the first device, to the first network, and subsequently to the second network where it is finally sent to the second device as will be described in greater detail below. Alternatively, the encrypted message may be sent from the first device directly to the second network where it is then sent to the second device.

In another example, the steps 210-223 can commence with the first network as sender rather than the first device. This example may occur if, for example, the first device does not implement the encryption methods of this invention but the first network does. In such an example, when the first device sends a text message to the second device, the communication is initially conducted via the unsecured SMS protocols of the related art between the first device and the first network. However, if the first network implements the methods of this invention, the process can start in step 210 where the first network is the sender and the first network can request/receive the public key of the second device in step 220.

If the sending device and the sending network do not implement encryption in accordance with the invention, the process may transition to step 230 where the text message is sent by the sending device and the sending network via conventional SMS and received by the subscriber network via conventional SMS 231. In this respect, the communication between the sender and the receiving network is insecure.

In step 232, however, after receiving the unencrypted SMS, the subscriber network can encrypt the SMS message with the public encryption key of the mobile device. The process can then proceed to decision step 240.

In decision step 240, the subscriber network can determine whether data service is available between the subscriber network and the intended recipient. In embodiments of the invention, the recipient device includes software implementing aspects of the invention and the network can ping the recipient device to ensure it is ready and able to receive data communications. If the recipient device can receive data communications, the process can proceed to step 250 where the encrypted message is sent via data services or, if the recipient device cannot receive data communications, the process can proceed to step 260 where the encrypted message can be sent via traditional SMS service.

In step 270, software on the recipient device can decrypt the encrypted message using the saved private key established during initial device registration. Where the encrypted message is received via data service, the encrypted message can be directly received by the software. Where the encrypted message is received via SMS, the software can review and import incoming SMS messages from a native SMS application. The decrypted SMS can be viewed the in the software application.

In optional step 280, the decrypted SMS can be exported to a native SMS application on the recipient device so that a user can access messages in familiar way.

Thus, there are multiple process flows through embodiments of the invention that incorporate, to the maximum extent possible, encrypted communications between a sender and receiver of SMS messages. In a best case scenario, both sender and receiver fully implement the encryption methods of this invention and messages are sent fully encrypted from sender to receiver. However, in the event that end-to-end encryption is not supported by the sender, the invention will encrypt unencrypted messages at the network provider level to provide middle-to-end encryption.

Although end-to-end encryption is preferred from a security standpoint, middle-to-end encryption can be sufficient in many scenarios. For example, where a first device is in a low-risk location such as the United States and a second device is in a high-risk location such as an adversarial nation, encrypting only the communications between a trusted network operator and the second device may be sufficient because the unencrypted communications are not accessible to the adversarial nation.

Embodiments of the invention are particularly suited for at least two use cases. First, distributing two factor authentication (2FA) codes, and second, encrypted communication between end users.

In distributing 2FA codes, a first device can be a provider of two factor authentication (2FA) codes, the second device can be a mobile phone, and both implement encryption as described in the invention. A user of the second device may attempt to access a website requiring two factor authentication such as a bank website. When attempting to log into the bank’s website, the bank may generate a 2FA code and send it to a 2FA service provider via encrypted data connection. The 2FA service provider may traditionally be configured to send the 2FA code to the second device via ordinary SMS. However, if the 2FA provider implements encryption in accordance with the invention, it can encrypt and send the 2FA code in accordance with steps 220-223 where it is subsequently sent to the second device via push or SMS in steps 250 or 260 and decrypted on the second device in step 270. In this scenario 2FA codes are protected from rogue network operators.

In encrypted communications between end users, communications are encrypted over at least the final half of transmission where they are most susceptible to interception. For users that value security or where security is a mission requirement, those users can avail themselves of network operators that implement encryption as provided herein.

In embodiments of the invention, key exchange mechanisms may be employed to establish shared secrets between communicating parties, enabling hybrid encryption schemes that combine the efficiency of symmetric encryption with the security properties of asymmetric cryptography. Two principal categories of key exchange algorithms are contemplated: classical key exchange protocols and post-quantum cryptographic (PQC) key exchange mechanisms.

Diffie-Hellman (DH) key exchange represents a foundational classical key exchange protocol that enables two parties to establish a shared secret over an insecure communication channel without prior exchange of secret material. In the DH protocol, both parties agree upon a large prime number p and a generator g. Each party independently generates a private key (a random integer) and computes a corresponding public value by raising the generator to the power of their private key modulo the prime. The parties exchange their public values, and each party then computes the shared secret by raising the received public value to the power of their own private key modulo the prime. The mathematical properties of modular exponentiation ensure that both parties arrive at the same shared secret, which can then be used as a symmetric encryption key or as input to a key derivation function. Elliptic Curve Diffie-Hellman (ECDH) provides an analogous key exchange mechanism using elliptic curve arithmetic, offering equivalent security with smaller key sizes and reduced computational overhead compared to traditional DH implementations.

However, classical key exchange protocols including DH and ECDH derive their security from the computational difficulty of the discrete logarithm problem, which is known to be efficiently solvable by quantum computers executing Shor's algorithm. The anticipated development of cryptographically relevant quantum computers poses a significant threat to communications protected by classical asymmetric cryptography, as adversaries may intercept and store encrypted communications today for later decryption when quantum computing capabilities become available.

Module-Lattice-Based Key-Encapsulation Mechanism (ML-KEM), standardized by the National Institute of Standards and Technology (NIST) as a post-quantum cryptographic algorithm, provides key exchange functionality that remains secure against both classical and quantum computational attacks. ML-KEM, derived from the CRYSTALS-Kyber algorithm, bases its security on the hardness of the Module Learning With Errors (MLWE) problem, which is believed to be computationally intractable for both classical and quantum computers. In ML-KEM key exchange, the recipient generates a public-private key pair and publishes the public key. The sender uses the recipient's public key to encapsulate a randomly generated shared secret, producing a ciphertext that can only be decapsulated by the holder of the corresponding private key. Upon receiving the ciphertext, the recipient applies their private key to recover the shared secret, which both parties can then use for symmetric encryption of message content.

Embodiments of the invention may implement ML-KEM to provide quantum-resistant key exchange, ensuring that encrypted communications remain secure against future quantum computing threats. In hybrid implementations, embodiments may combine classical ECDH key exchange with ML-KEM, deriving the final shared secret from both mechanisms to provide security against both classical attacks (in the event of undiscovered vulnerabilities in lattice-based cryptography) and quantum attacks (which threaten classical algorithms). The selection of key exchange mechanism may be negotiated between communicating parties based on their respective cryptographic capabilities, with the system defaulting to the strongest mutually supported algorithm.

It will be apparent to those skilled in the art that various modifications and variations can be made in the method for providing asymmetric encryption for SMS communications without departing from the spirit or scope of the invention. Thus, it is intended that embodiments of the invention cover the modifications and variations of this invention provided they come within the scope of the appended claims and their equivalents.

What is claimed is:

1. A method for securely transmitting a two-factor authentication (2FA) code, the method comprising:
generating a public key and a private key associated with a mobile subscriber;
storing the private key on a mobile device of the mobile subscriber;
sharing the public key with a 2FA distribution service;
receiving by the, 2FA distribution service, a 2FA code for the mobile subscriber;
generating an encrypted 2FA code with the public key;
sending the encrypted 2FA code to a mobile network of the mobile subscriber;
sending, by the mobile network, the encrypted 2FA code to the mobile device; and
decrypting, by the mobile device the encrypted 2FA code using the private key.

2. The method of claim 1 wherein the sending the encrypted 2FA code to the mobile device is performed over SMS.

3. The method of claim 1 wherein the sending the encrypted 2FA code to the mobile device is performed over the Internet.

4. The method of claim 1 wherein the decrypting is performed by an application on the mobile device.

5. The method of claim 1 further comprising:
inserting the unencrypted text message into a native text messaging application of the mobile device.

6. The method of claim 1 wherein the sending of the encrypted 2FA code to the mobile device includes routing the encrypted 2FA code to a roaming network to which the mobile device is registered.

7. A method for encrypting text messages in transit, the method comprising:
generating a public key and a private key associated with a mobile subscriber;
storing the private key on a mobile device of the mobile subscriber;
receiving, by a home network, an unencrypted text message for a mobile subscriber;
encrypting the unencrypted text message using the public key to create an encrypted text message;
sending the encrypted text message to the mobile device; and
decrypting the encrypted text message using the private key on the mobile device to yield the unencrypted text message.

8. The method of claim 2 wherein the sending of the encrypted text message to the mobile device includes routing the encrypted text message to a roaming network to which the mobile device is registered.

9. The method of claim 2 wherein unencrypted text message is a 2FA code.

10. The method of claim 2 wherein the sending the encrypted text message to the mobile device is performed over SMS.

11. The method of claim 2 wherein the sending the encrypted text message to the mobile device is performed over the Internet.

12. The method of claim 2 wherein the decrypting is performed by an application on the mobile device.

13. The method of claim 2 further comprising:
inserting the unencrypted text message into a native text messaging application of the mobile device.

14. A method for providing end-to-end encryption for text messages, the method comprising:
generating a public key and a private key associated with a first device;
storing the public key on a mobile network;
requesting, by a mobile device, the public key;
generating an encrypted text message from an unencrypted text message using the public key;
sending the encrypted text message to the mobile network by the second device;
sending the encrypted text message to the first device by the mobile network; and
decrypting the encrypted text message using the private key on the first device.

15. The method of claim 14 wherein the sending is performed via SMS.

16. The method of claim 14 wherein the sending is performed via the Internet.

17. The method of claim 14 wherein the sending is performed via SMS and the Internet.

18. The method of claim 14 wherein at least one of the first device and the second device is registered with a roaming network and the encrypted text message is encrypted while traversing a network infrastructure of the roaming network.
